(19) United States
(12) Patent Application Publication
(10) Pub. No.: US 2006/0044362 A1
(43) Pub. Date: Mar. 2, 2006

(54) Inkjet printer head and method of fabricating the same

(76) Inventors: Kyong-il Kim, Seoul (KR); Myong-jong Kwon, Suwon-si (KR); Kwang-ryul Kim, Suwon-si (KR); Nam-kyun Kim, Seongnam-si (KR); Byung-ha Park, Suwon-si (KR); Yong-shik Park, Seongnam-si (KR); Eun-bong Han, Suwon-si (KR); Young-ung Ha, Suwon-si (KR); Sung-joon Park, Suwon-si (KR); Jae-Sik Min, Suwon-si (KR)

Correspondence Address: STANZIONE & KIM, LLP, 919 18TH STREET, N.W., SUITE 440, WASHINGTON, DC, 20006, US

(21) Appl. No.: 11/059,501

(22) Filed: Feb. 17, 2005

(30) Foreign Application Priority Data
Aug. 25, 2004 (KR) 2004-67288

(51) Int. Cl. B41J 2/05

(52) U.S. Cl. 347/71

(57) ABSTRACT

An inkjet printer head and method of fabricating the same includes a substrate having an ink-feed hole formed at a bottom surface of the substrate, a lower chamber formed at a top surface of the substrate, and a restrictor to fluid communicate between the ink-feed hole and the lower chamber, an oxide layer formed on the substrate, a heater formed on the oxide layer and disposed parallel to the surface of the substrate to cross the lower chamber, a lead electrically connected to the heater, and a nozzle layer disposed on the heater to configure an ink channel together with the lower chamber and having a nozzle at an upper portion of the nozzle layer. The inkjet printer head is capable of improving a thermal efficiency by heating the ink using both surfaces of the heater since the heater is disposed at a center of the ink chamber, and improving characteristics of the heater by making a current density and a current flow uniform since the heater is formed in a straight line without any bent or curved portion.

### CROSS-REFERENCE TO RELATED APPLICATIONS

This application claims the benefit under 35 U.S.C. §119 of Korean Patent Application No. 2004-67288, filed Aug. 25, 2004, the disclosure of which is incorporated herein by reference and in its entirety.

### BACKGROUND OF THE INVENTION

1. Field of the Invention

The present general inventive concept relates to an inkjet printer head and method of fabricating the same, and more particularly, to an inkjet printer head used with an inkjet printer to eject ink and a method of manufacturing the same.

2. Description of the Related Art

An inkjet printer is an image forming apparatus for obtaining a desired shape of printed images by ejecting fine droplets of ink stored in a cartridge to a surface of a recording medium. The ink stored in the cartridge is ejected through a head. At this time, a method for ejecting ink may be generally classified into two methods, i.e., a thermal driving method for ejecting the ink droplets using the pressure of bubbles in the ink caused by heat generated from a heater in the head, and a piezoelectric driving method for ejecting the ink droplets using the pressure applied to the ink due to mechanical deformation of a piezoelectric material by energizing the piezoelectric material.

Referring to FIG. 1, a conventional thermal driving type inkjet printer head is illustrated. The head has an ink-feed hole 12 formed in a substrate 10 to supply ink from an ink cartridge to the head, and a chamber layer 14 formed on the substrate 10 having a restrictor 16 for supplying the ink from the ink feed hole 12 into the chamber layer 14 and an ink chamber 18 for temporarily storing the supplied ink. A nozzle 20 is formed above the chamber layer 14, and a heater 22 is formed under the nozzle 20. Meanwhile, in order to prevent the heater 22 from being damaged due to a reaction of the heater 22 and the ink, a passivation layer 24 is formed on a top surface of the heater 22. In addition, the heater 22 is connected to a pad 26, and the pad 26 is connected to a main body of an inkjet printer through a flexible PCB (not shown).

Meanwhile, when a pulse current is applied to the heater 22, the heater 22 is instantly heated to generate bubbles 30 on the surface of the heater 22, and ink droplets 28 are discharged through the nozzle 20 by a pressure increased due to the bubbles 30. However, in the heater 22 as shown in FIG. 1, the heat is transferred through only the top surface thereof, therefore heat generated from a bottom surface of the heater 22 increases a temperature of the chamber layer 14 and does not heat the ink. Moreover, the passivation layer 24 located on the top surface of the heater 22 makes a heat transfer efficiency lower.

In order to solve the above problem, as shown in FIG. 2, U.S. Pat. No. 6,669,333 discloses another conventional inkjet printer head. Referring to FIG. 2, a chamber layer 54 is formed on a substrate 50 having an ink-feed hole 52 and a restrictor 56, and a heater 58 for heating the ink introduced through the restrictor 56 is located at a center of an ink chamber 57 to heat the ink at both surfaces of the heater 58. In the conventional inkjet printer head of FIG. 2, if there is no necessity to form a passivation layer due to use of ink having a conductivity lower than a conventional ink, the heat transfer efficiency may be improved. Since the heating is performed at both surfaces of the heater 58, the ink droplets may be ejected using an electric power smaller than in the conventional inkjet printer head of FIG. 1.

In addition, when an electric current is not applied to the heater after ejecting the droplets, the bubbles are reduced and apply a cavitation force on a surface of the heater 58, and as a result, the heater 58 can be deformed or damaged. However, in the heater 58 of FIG. 2, since generation or extinction of the bubbles are performed in directions opposite to each other at both surfaces of the heater, the cavitation force is offset to remarkably reduce influence on the heater 58, thereby extending a lifetime of the heater 58.

FIGS. 3A to 3D illustrate processes of forming the heater 58 of the conventional inkjet printer head of FIG. 2. That is, the restrictor 56 is formed in the substrate 50, and then a passivation layer is formed on the substrate 50 (see FIG. 3A). Next, the chamber layer 54 is formed on the passivation layer (see FIG. 3B), and a thin layer 58′ made of a heater material is formed on the chamber layer 54 (see FIG. 3C). Finally, the thin layer 58′ is patterned to form the heater 58 as shown in FIG. 3D.

However, since the heater 58 of the conventional inkjet printer head of FIG. 2 is shaped in a right-angle structure other than in a planar structure as in the conventional inkjet printer head of FIG. 1, the heater 58 may have a thickness formed irregularly at a bent portion A (FIG. 2). That is, the heater 58 is generally made by depositing a heater material using a sputtering or chemical vapor deposition (CVD) method, and then patterning the heater material. Therefore, as shown, it is difficult to form the heater 58 to have a desired thickness at the bent portion A of a right angle. That is, since the thickness of the thin layer 58′ becomes irregular around the bent portion A, when the bent portion A has a thin thickness, there is a high probability of an electrical short circuit due to a concentration of a current density. Therefore, a bent heater has a disadvantage in productivity as well as a difficulty in precisely adjusting a calorific value of the heater during operation, thereby badly affecting characteristics of the heater as a whole.

### SUMMARY OF THE INVENTION

The present general inventive concept provides an inkjet print head having a heater capable of heating ink at both sides of the heater since the heater exists at a center of an ink chamber, and improving concentration of a current density and a current flow by changing a shape of the heater.

The present general inventive concept also provides a method of fabricating an inkjet printer head capable of uniformly forming a shape of a thin layer, which is to be a heater when the heater is manufactured to heat the ink at both sides of the heater.

Additional aspect and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an inkjet printer head provided with a heater disposed in a planar structure without a bent portion. The inkjet printer head may include a substrate having an ink-feed hole formed at a bottom surface of the substrate, a lower chamber formed at a top surface of the substrate, and a restrictor to fluid communicate with the ink-feed hole and the lower chamber, an oxide layer formed on the substrate, a heater formed on the oxide layer and disposed parallel to top surface of the substrate to cross the lower chamber, a lead electrically connected to the heater, and a nozzle layer disposed on the heater to configure an ink channel together with the lower chamber and having a nozzle at an upper portion of the nozzle layer.

The lower chamber may be formed under the top surface of the substrate, and the heater may be disposed parallel to the substrate, so that the heater is suspended at a center of a chamber and formed in a straight manner without the bent portion when viewing from a side angle.

The heater and the lead may be separately formed and connected to each other, or may be integrally formed in one layer and have different resistance values from each other by implanting impurities thereto.

The head may include at least two individually operated heaters. Dimensions of the ejected ink droplets may be adjusted through the heaters.

The heater may have a slit passing therethrough. The slit may minimize an influence of an ink supply pressure applied to the heater by the ink supplied from the ink-feed hole, and reduce an influence of a cavitation force.

The substrate may be made of a silicon wafer.

The foregoing and/or other aspects and advantages of the present general inventive concept may also be achieved by providing a method of fabricating an inkjet printer head, the method including etching a top surface of a substrate to form a lower chamber, forming a restrictor at a bottom surface of the lower chamber, forming an oxide layer on the substrate at which the restrictor is formed, forming a first sacrificial layer in the lower chamber and the restrictor, forming a heater and a lead on the first sacrificial layer and the substrate, forming a second sacrificial layer on the lower chamber, forming a nozzle layer configuring an upper chamber on a top surface and side surfaces of the sacrificial layer and the substrate around the second sacrificial layer, forming an ink-feed hole at a rear surface of the substrate, removing the first and second sacrificial layers in the lower and upper chambers, and removing the oxide layer remaining at a bottom surface of the restrictor.

The foregoing and/or other aspects and advantages of the present general inventive concept may also be achieved by providing a method of fabricating an inkjet printer head, the method including etching a top surface of a substrate to form a lower chamber, forming an oxide layer on the substrate, forming a first sacrificial layer in the lower chamber and a restrictor, forming a heater and a lead on the first sacrificial layer and the substrate, forming a second sacrificial layer on the lower chamber, forming a nozzle layer configuring an upper chamber on a top surface and side surfaces of the sacrificial layer and the substrate around the second sacrificial layer, forming an ink-feed hole at a rear surface of the substrate, forming the restrictor on a top surface of the ink-feed hole, removing the first and second sacrificial layers in the lower and upper chambers, and removing the oxide layer remaining at a top surface of the restrictor.

The above mentioned two manufacturing methods have a difference between a timing of the forming of the restrictor, but the heater may be formed parallel to the substrate without any bent portion.

The first and second sacrificial layers formed in the lower and upper chambers may be made of different materials from each other, and may be individually removed. For example, the first sacrificial layer in the lower chamber may be made of polysilicon, and the second sacrificial layer in the upper chamber may be made of a photoresist material. In this case, the sacrificial layer made of the polysilicon may be removed by a dry etching method using a XeF₂, and the sacrificial layer made of the photoresist material may be removed by a wet etching method. This is because it is possible to reduce a probability of damaging the surface of the heater when both sacrificial layers are removed by the wet etching method.

The first and second sacrificial layers in the lower and upper chambers may be made of the same material to be simultaneously removed. In this case, since a process of removing the sacrificial layers is shortened, its productivity may be effectively improved.

The oxide layer may be removed by a CHF₃ gas through the rear surface of the substrate.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating a conventional inkjet printer head;

FIG. 2 is a cross-sectional view illustrating another conventional inkjet printer head;

FIGS. 3A to 3D are perspective views illustrating processes of fabricating the conventional inkjet printer head of FIG. 2;

FIG. 4 is a cross-sectional view illustrating an inkjet printer head according to an embodiment of the present general inventive concept;

FIG. 5 is a cross-sectional view illustrating an inkjet printer head according to another embodiment of the present general inventive concept;

FIG. 6 is a perspective view illustrating the inkjet printer head of FIG. 4, in which a nozzle layer is removed;

FIGS. 7A to 7J are cross-sectional views each illustrating a process of fabricating the inkjet printer head of FIG. 4 according to an embodiment of the present general inventive concept; and

FIGS. 8A to 8K are cross-sectional views each illustrating a process of fabricating the inkjet printer head of FIG. 4 according to another embodiment of the present general inventive concept.

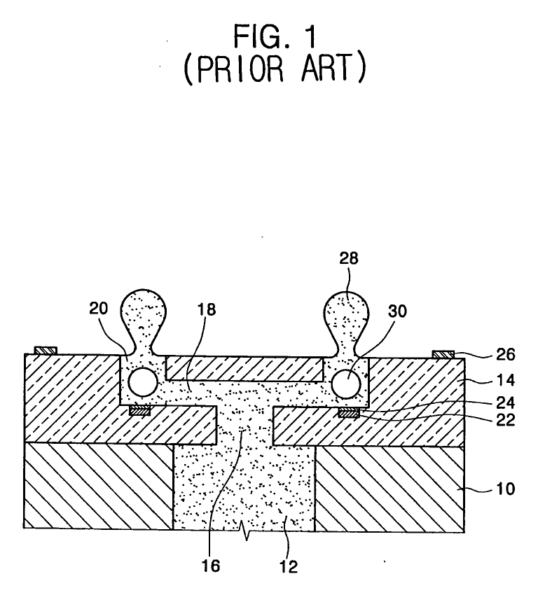

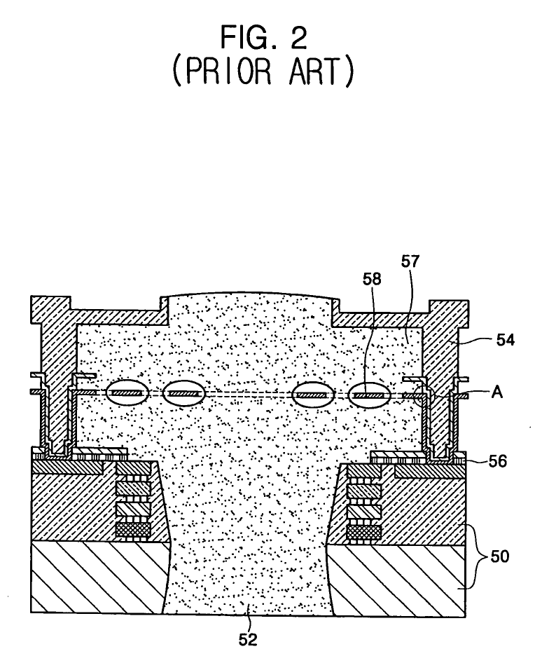

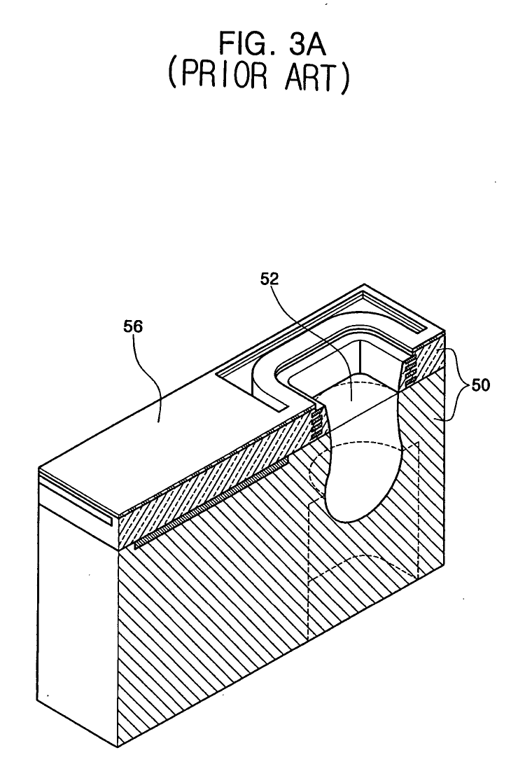

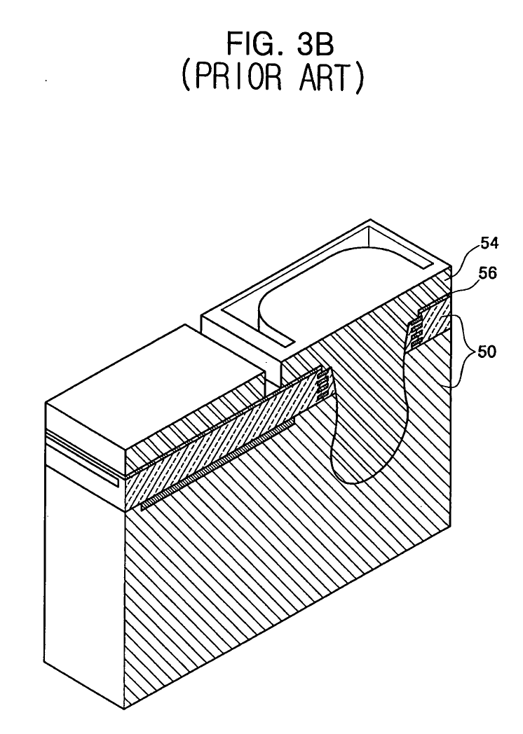

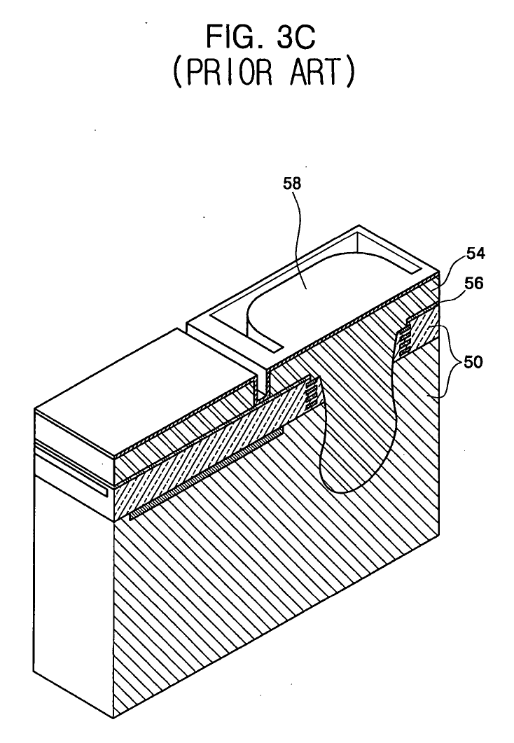

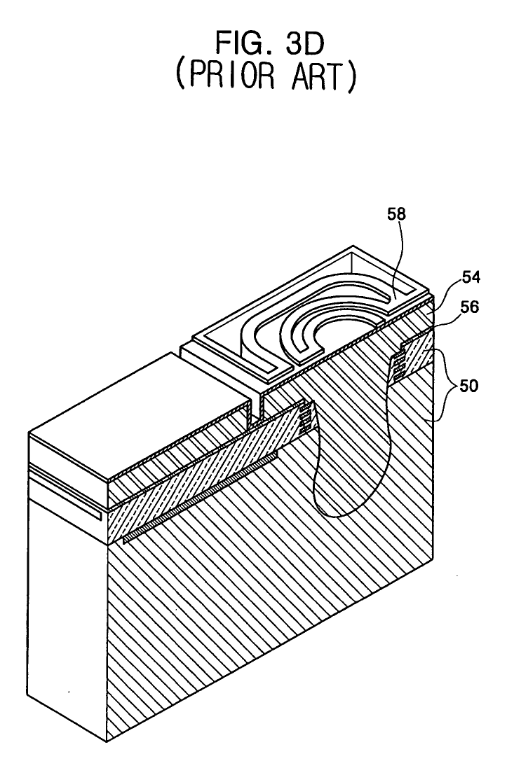

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, embodiments of an inkjet printer head and method of fabricating the same according to the present general inventive concept will be described in conjunction with the accompanying drawings.

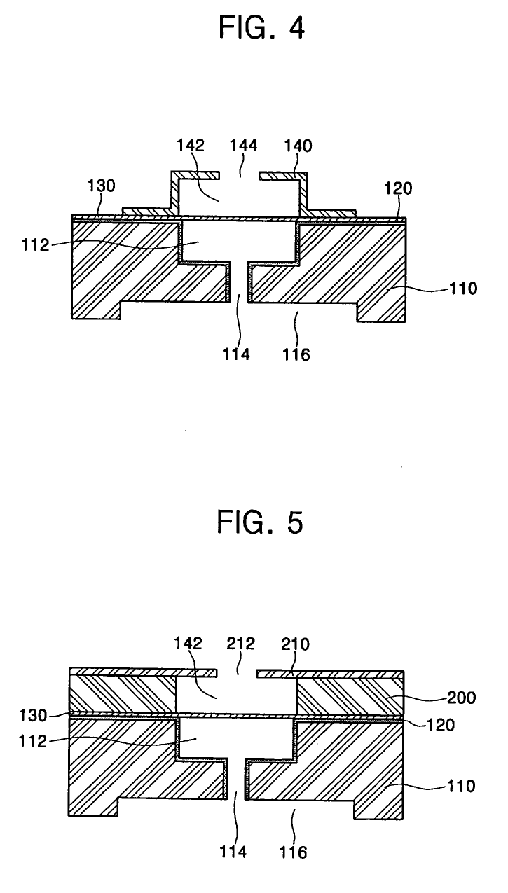

Referring to FIG. 4, a substrate 110 in an inkjet printer head according to an embodiment of the present general inventive concept can be made of a silicon wafer, and a surface of the substrate 110 is partially etched to form a lower chamber 112. A restrictor 114 is formed at a bottom surface of the lower chamber 112, and is in fluid communication with an ink-feed hole 116 formed at a bottom surface of the substrate 110. Therefore, ink in an ink cartridge (not shown) is introduced into the lower chamber 112 through the ink-feed hole 116 and the restrictor 114.

Meanwhile, an oxide layer 120 is formed on the substrate 110. The oxide layer 120 prevents the substrate 110 from being damaged during a process of removing a sacrificial layer, and functions to isolate a heater and a lead to be treated later from the substrate.

A heater and lead layer 130 is disposed on the oxide layer 120. As shown, the heater and lead layer 130 is disposed in a straight line along the surface of the substrate 110 without any bent or curved portion. Therefore, a thin layer to form the heater and lead layer 130 may be formed in a planar structure by a deposition method to thereby have a uniform thickness. As a result, the heater and lead layer 130 may have a uniform current density and current flow during an operation of the heat and lead layer 130 to thereby maintain good heating characteristics.

Meanwhile, a nozzle layer 140 is disposed on the heater and lead layer 130 to define an upper chamber 142. An ink chamber is configured by the upper and lower chambers 142 and 112 to temporarily store the ink supplied from the ink-feed hole 116. A nozzle 144 is formed in the top portion of the nozzle layer 140, and the ink is discharged through the nozzle 144.

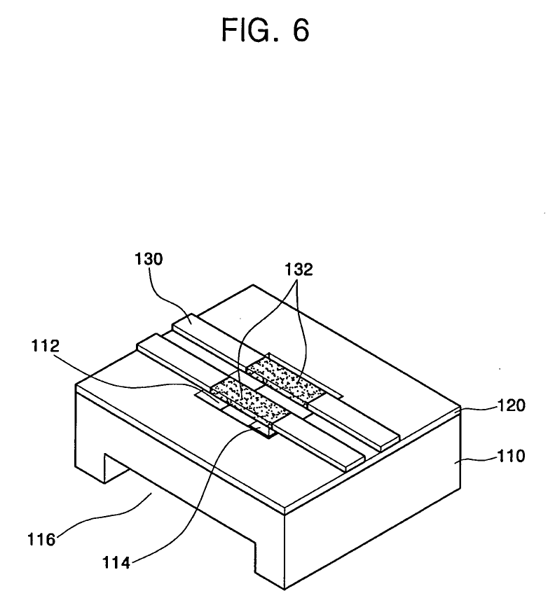

FIG. 6 illustrates the heater and lead layer 130 of the inkjet printer head of FIG. 4. Referring to FIG. 6, the heater and lead layer 130 can be integrally formed in one layer, and impurities are implanted into a portion 132 so that the portion 132 has a resistance higher than a remaining portion of the heater and lead layer 130. That is, a heater and a lead may be formed in the one layer. In addition, two individually operated heater and lead layers 130 may be disposed to cross over the lower chamber 112 to adjust dimensions of droplets ejected through the nozzle 144. Further, since each of the heater and lead layers 130 has a small width, the layers 130 are less affected by an ink flow or a cavitation force.

Meanwhile, FIG. 5 illustrates an inkjet printer head according to another embodiment of the present general inventive concept. The inkjet printer head of FIG. 5 is basically similar to the inkjet printer head of FIG. 4, except that the ink jet printer head of FIG. 5 is provided with an upper chamber layer 200 separately formed to configure the upper chamber 142, and a nozzle layer 210 is formed on the upper chamber layer 200. A nozzle 212 to eject the ink is formed in the nozzle layer 210. Since the upper chamber layer 200 and the nozzle layer 210 are separately formed, the inkjet printer head of FIG. 5 may have a disadvantage in that a fabrication process may be complicated compared to a fabrication process of the inkjet printer head of FIG. 4. However, since the nozzle layer 210 is formed in a planar structure over a length of the inkjet printer head of FIG. 5, wiping of the nozzle layer 210 may be more readily performed.

Hereinafter, embodiments of a method of fabricating the inkjet printer head of FIG. 4 according to the present general inventive concept will be described.

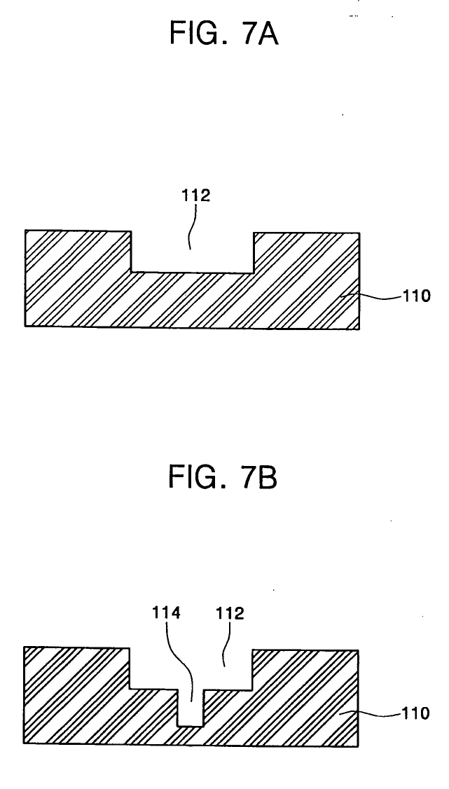

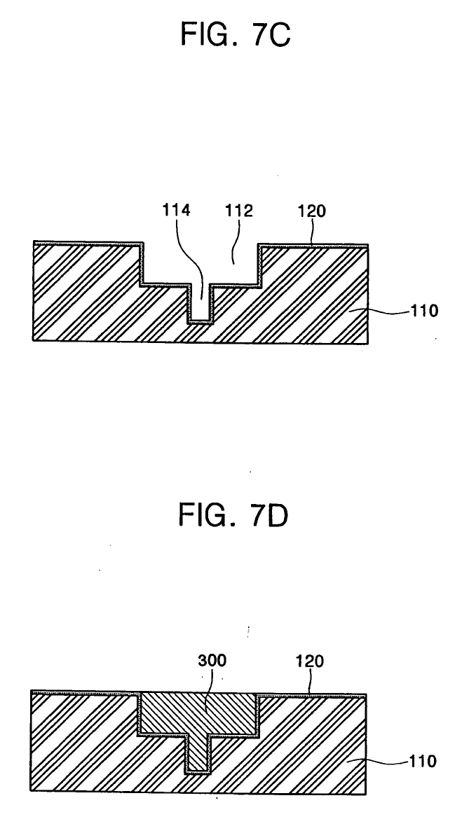

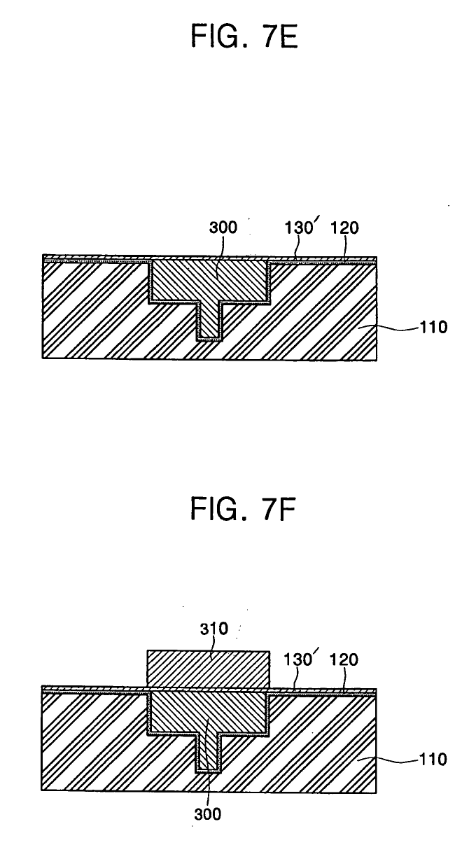

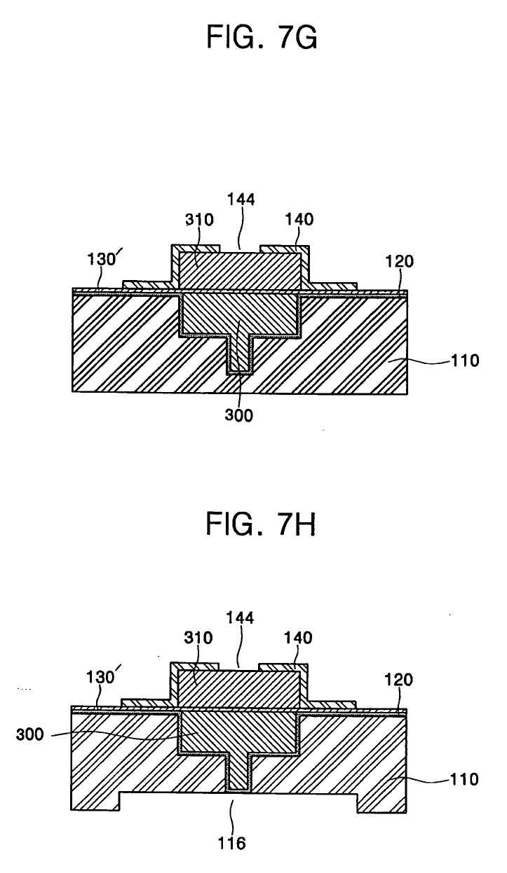

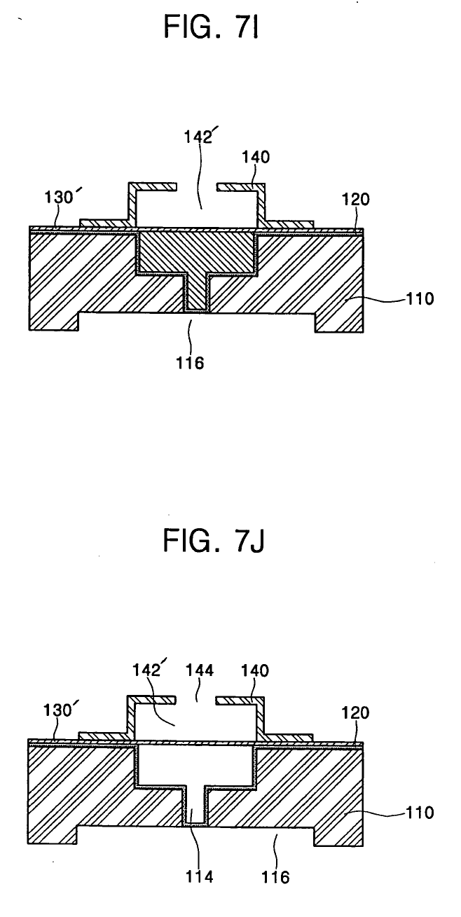

FIGS. 7A to 7J illustrate a method of fabricating the inkjet printer head of FIG. 4 according to an embodiment of the present general inventive concept. As shown in FIG. 7A, the substrate 110 made of a silicon wafer is prepared, and then a top surface of the substrate 110 is etched to form the lower chamber 112. The lower chamber 112 may be formed by a dry etching method after forming an etching mask on the top surface of the substrate 110. Next, the bottom surface of the lower chamber 112 is etched to form the restrictor 114 (see FIG. 7B). The restrictor 114 can be formed to have a depth such that a lower portion of the restrictor 114 is in fluid communication with the ink-feed hole 116 in consideration of a depth of the ink-feed hole 116, which is to be described hereinafter, but does not pass through the substrate 110 since an oxide layer may be formed on a bottom surface of the restrictor 114.

When the formation of the restrictor is completed, the oxide layer 120 is formed on the top surface of the substrate 110 including surfaces of the lower chamber 112 and the restrictor 114 (see FIG. 7C). As described above, the oxide layer 120 insulates the heater and lead layer 130 from the substrate 110 and prevents gas penetration during an etching process. The oxide layer 120 may be formed by a thermal oxidation method, a plasma enhanced chemical vapor deposition (PECVD) method, or a low pressure chemical vapor deposition (LPCVD) method.

When the process of forming the oxide layer 120 is completed, a first sacrificial layer 300 is formed in the lower chamber 112 and the restrictor 114 (see FIG. 7D). The first sacrificial layer 300 may be formed of polysilicon, and acts as a base to form a heater layer, which is to be described hereinafter.

When the formation of the first sacrificial layer 300 is completed, a thin layer made of a heater material is formed on the first sacrificial layer 300 and the substrate 110 by a deposition method, and then patterned to form a heater layer 130′ (see FIG. 7E). The heater material may be a material containing any one selected from TaNx, TiNx, WNx, TaAl, Ta—Si—N and W—Si—N. Next, a lead layer (not shown) made of metal is formed on the heater layer 130 by the same process. At this time, as described above, a method of forming one layer to form a heater and a lead instead of the heater layer 130′, and then, implanting impurities to increase the resistance of the heater part may be considered.

When the formation of the heater layer 130′ is completed, a second sacrificial layer 310 is formed to partially cover the lower chamber 112 and the heater layer 130′ (see FIG. 7F). The second sacrificial layer 310 may be formed by applying a photoresist using a photolithography method, which can be used to form the upper chamber 142. Then, the nozzle layer 140 having the nozzle 144 is formed on the second sacrificial layer 310 (see FIG. 7G).

When the formation of the nozzle layer 140 is completed, an etching mask can be formed at the bottom surface of the substrate 110, and then a portion of the bottom surface of the substrate 110 is etched to form the ink-feed hole 116 (see FIG. 7H). The ink-feed hole 116 can be formed to have a height from the bottom surface of the substrate 110 to a bottom surface of the oxide layer 120 formed at the bottom surface of the restrictor 114.

Next, the second sacrificial layer 310 made of the photoresist existing in the upper chamber 142 is removed through the nozzle 144 by a wet etching method (see FIG. 71). In addition, the first sacrificial layer 300 made of polysilicon filled in the lower chamber 112 is removed by a dry etching method using a XeF₂ gas to form an ink chamber 142′ (see FIG. 7j). At this time, the oxide layer 120 disposed on the bottom surfaces of the lower chamber 112 and the restrictor 114 prevents the XeF₂ gas from arriving at the bottom surface of the substrate 110 to thereby precisely remove only the polysilicon existing in the lower chamber.

Finally, when the oxide layer 120 disposed on the bottom surface of the restrictor 114 is removed, the manufacture of the inkjet printer head shown in FIG. 4 is completed. At this time, the oxide layer 120 may be removed using a CHF₃ gas.

Meanwhile, while the first and second sacrificial layers 300 and 310 filled in the lower and upper chambers 112 and 142 are described above as being formed of different materials from each other, the first and second sacrificial layers 300 and 310 may be formed using the same material, such as the photoresist. In this case, although the heater may be damaged during the process of removing the photoresist, as a result of a real test, it has been confirmed that there is no damage affecting a performance and a lifetime of the heater. Therefore, since the first and second sacrificial layers 300 and 310 may be made of the same material and be simultaneously removed through the nozzle 144, the manufacturing process may be reduced.

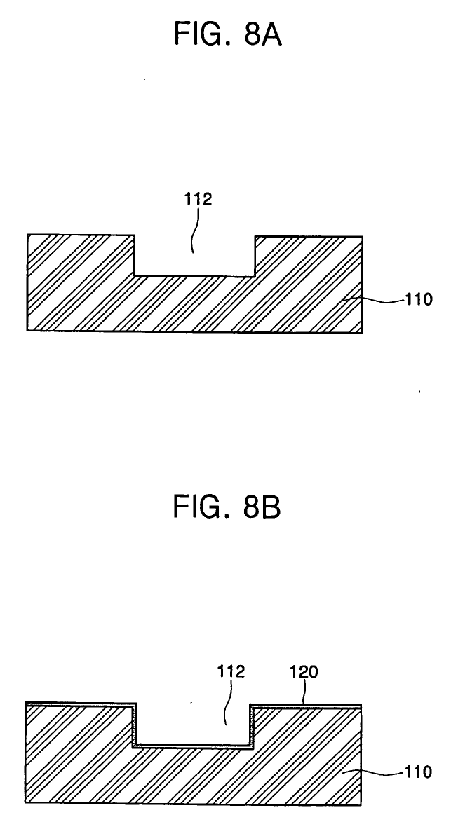

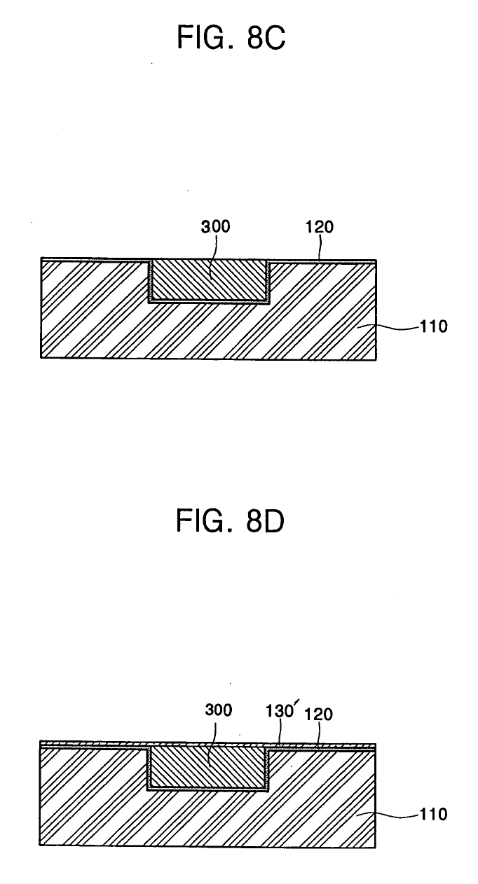

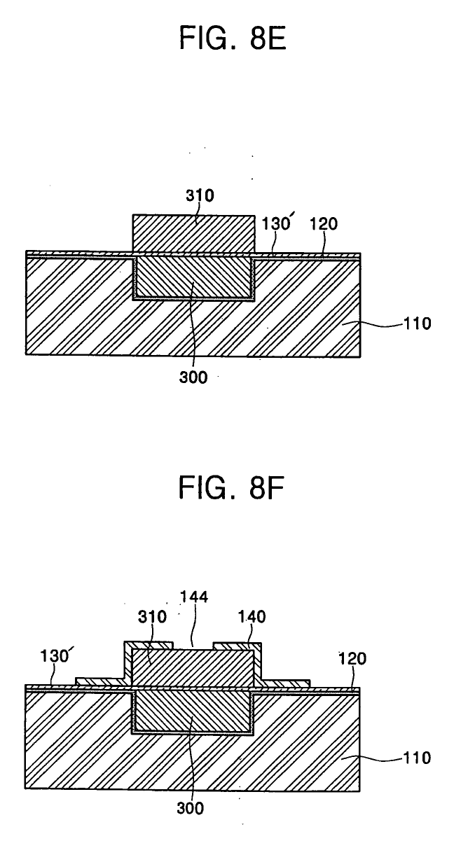

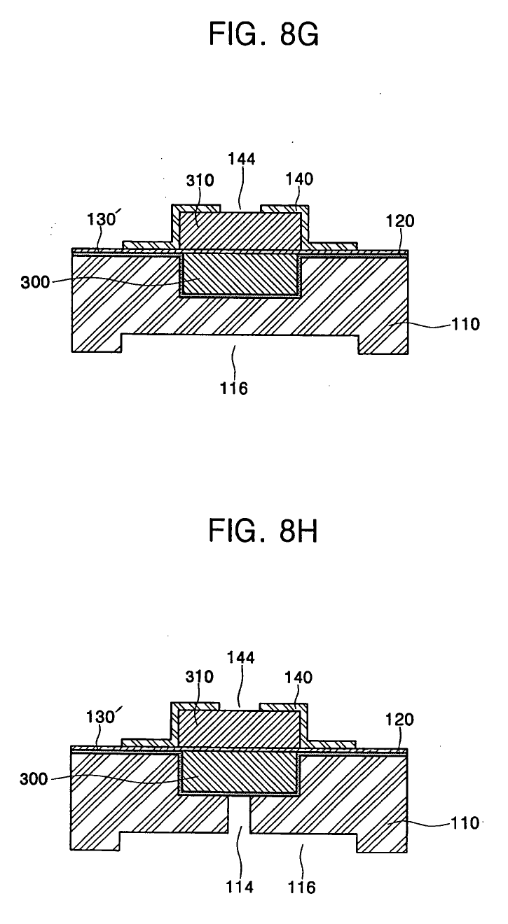

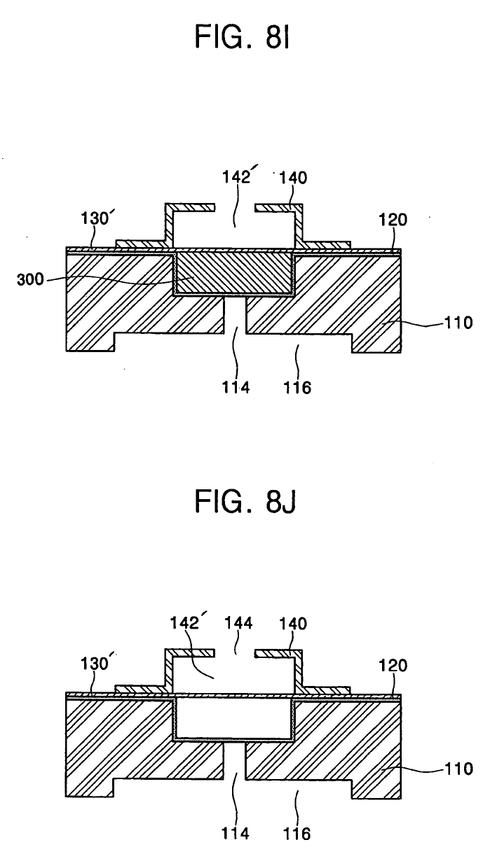

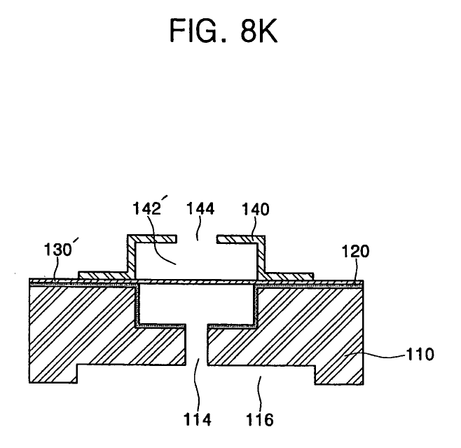

FIGS. 8A to 8K illustrate a method of fabricating the inkjet printer head of FIG. 4 according to another embodiment of the present general inventive concept.

The method of FIGS. 8A to 8K is basically similar to the method of FIGS. 7A to 7J, except that the lower chamber 112 is formed on the substrate 110 (see FIG. 8A), and then the oxide layer 120 is formed on the substrate 110 without forming a restrictor (see FIG. 8B).

The following processes, i.e., forming the first sacrificial layer 300 of the lower chamber 112 (see FIG. 8C), forming the heater layer 130′ (see FIG. 8D), forming the second sacrificial layer 310 of the upper chamber 142 (see FIG. 8E), forming the nozzle layer 140 (see FIG. 8F), and forming the ink-feed hole 116 (see FIG. 8G) are the same as in the method of FIGS. 7A to 7J. However, the method of FIGS. 8A to 8K is different from the method of FIGS. 7A to 7J in that the ink-feed hole 116 is formed, and then a top surface of the ink-feed hole 116 is etched to form the restrictor 114.

Next, the first and second sacrificial layers 300 and 310 formed in the upper and lower chambers 142 and 112 are removed (see FIGS. 8I and 8J), and then the oxide layer 120 disposed on the restrictor 114 and located at the bottom surface of the lower chamber 112 is removed to complete the manufacture of the inkjet printer head (see FIG. 8K).

In the method of FIGS. 8A to 8K, the first and second sacrificial layers 300 and 310 may be formed of the same material to be simultaneously removed.

As can be seen from the foregoing, the present general inventive concept is capable of improving a thermal efficiency by heating ink using both surfaces of a heater since the heater is disposed at a center of an ink chamber, and improving characteristics of the heater by making a current density and a current flow uniform since the heater is formed in a straight line without any bent or curved portion.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printer head comprising:
a substrate having an ink-feed hole formed at a lower surface of the substrate, a lower chamber formed at an upper surface of the substrate, and a restrictor to fluid communicate with the ink-feed hole and the lower chamber;
an oxide layer formed on the substrate;
a heater formed on the oxide layer and disposed parallel to the upper surface of the substrate to cross the lower chamber;
a lead electrically connected to the heater; and
a nozzle layer disposed on the heater to configure an ink channel together with the lower chamber and having a nozzle at its upper portion.

2. The inkjet printer head according to claim 1, wherein the heater and the lead are integrally formed in one layer, and impurities are implanted into the one layer to allow the heater and the lead to have different resistance values from each other.

3. The inkjet printer head according to claim 1, wherein the head comprises at least two individually operated heaters.

4. The inkjet printer head according to claim 1, wherein the heater comprises a slit passing to allow ink to pass therethrough.

5. The inkjet printer head according to claim 1, wherein the substrate is made of a silicon wafer.

6. The inkjet printer head according to claim 1, further comprising:
a chamber layer formed between the heater and the nozzle layer to form an upper chamber.

7. The inkjet printer head according to claim 6, wherein the heater extends from the oxide layer to cross over the lower chamber.

8. The inkjet printer head according to claim 1, wherein the heater and the lead are disposed on the same plane parallel to the upper surface of the substrate.

9. The inkjet printer head according to claim 1, wherein the heater does not have a bent portion with respect to the upper surface of the substrate.

10. A method of fabricating an inkjet printer head, comprising:
etching a top surface of a substrate to form a lower chamber;
forming a restrictor at a bottom surface of the lower chamber;
forming an oxide layer on the top surface of the substrate;
forming a first sacrificial layer in the lower chamber and the restrictor;
forming a heater and a lead on the first sacrificial layer and the substrate;
forming a second sacrificial layer on the lower chamber;
forming a nozzle layer configuring an upper chamber on a top surface and side surfaces of the second sacrificial layer and the substrate around the second sacrificial layer;
forming an ink-feed hole at a bottom surface of the substrate;
removing the first and second sacrificial layers; and
removing the oxide layer remaining at a bottom surface of the restrictor.

11. The method according to claim 10, wherein the first and second sacrificial layers are made of different materials from each other and individually removed.

12. The method according to claim 11, wherein the first sacrificial layer is made of polysilicon, and the second sacrificial layer is made of a photoresist material.

13. The method according to claim 12, wherein the first sacrificial layer is removed by a dry etching method using a XeF₂.

14. The method according to claim 12, wherein the second sacrificial layer is removed by a wet etching method.

15. The method according to claim 10, wherein the first and second sacrificial layers are made of the same material and simultaneously removed.

16. The method according to claim 10, wherein the oxide layer remaining at the bottom surface of the restrictor is removed by a CHF₃ gas through the bottom surface of the substrate.

17. A method of fabricating an inkjet printer head, comprising:
etching a top surface of a substrate to form a lower chamber;
forming an oxide layer on the substrate;
forming a first sacrificial layer in the lower chamber;
forming a heater and a lead on the first sacrificial layer and the substrate;
forming a second sacrificial layer on the lower chamber;
forming a nozzle layer configuring an upper chamber on a top surface and side surfaces of the second sacrificial layer and the substrate around the second sacrificial layer;
forming an ink-feed hole at a bottom surface of the substrate;
forming a restrictor on a top surface of the ink-feed hole;
removing the first and second sacrificial layers; and
removing the oxide layer remaining at a top surface of the restrictor.

18. The method according to claim 17, wherein the first and second sacrificial layers are made of different materials from each other and individually removed.

19. The method according to claim 18, wherein the first sacrificial layer is made of polysilicon, and the second sacrificial layer is made of a photoresist material.

20. The method according to claim 19, wherein the first sacrificial layer is removed by a dry etching method using a XeF₂.

21. The method according to claim 19, wherein the second sacrificial layer is removed by a wet etching method.

22. The method according to claim 17, wherein the first and second sacrificial layers are made of the same material and simultaneously removed.

23. The method according to claim 17, wherein the oxide layer remaining at the top surface of the restrictor is removed by a CHF₃ gas through the bottom surface of the substrate.
